(19) United States
(12) Patent Application Publication
(10) Pub. No.: US 2017/0206722 A1
(43) Pub. Date: Jul. 20, 2017

(54) Bluetooth Low Energy for Access Control

(71) Applicant: Deja View Concepts, Inc., Hingham, MA (US)

(72) Inventors: Carl Brown, Hingham, MA (US); James Martin, Hingham, MA (US)

(21) Appl. No.: 15/324,752

(22) PCT Filed: Jul. 9, 2015
(86) PCT No.: PCT/US15/39725

§ 371 Date: Jan. 9, 2017

Related U.S. Application Data
(60) Provisional application No. 62/022,420, filed on Jul. 9, 2014.

(51) Int. Cl. G07C 9/00; H04W 4/00

(52) U.S. Cl. CPC G07C 9/00309; H04W 4/008; G07C 2009/00769

(57) ABSTRACT

A system for accessing a secured area with a device that does not need to be actively operated. The system operates by receiving credential information from a beacon, sending that information as well as its own credential information to a secure server and operating the entrance to the area if the device's credential information to a secure server and operating the entrance to the area if the device's credentials are authorized to operate the mechanism associated with the beacon.

### CROSS REFERENCE TO RELATED APPLICATION

This application takes priority from and claims the benefit of U.S. Provisional Application Ser. No. 62/022,420 filed on Jul. 9, 2014, the contents of which are herein incorporated by reference.

### BACKGROUND OF THE INVENTION

Field of the Invention

The instant system relates generally to systems for remote actuation, validation and secure access, and more specifically to a system which allows secure access to buildings, rooms and the like.

Description of Related Art

Existent systems for hands free operation of doors currently rely on optical or mechanical sensors. While such systems may provide convenience, many such systems allow any person possessing a pass to actuate the sensor access to the associated door mechanism. These systems also lack the ability to track which person or persons have entered that door access mechanism.

Other means of secure access through doorways involve taping or sliding a key card to a card reader that identifies the card and allows the user through the door when the user credentials authorize access. Such systems provide a modicum of security, but can be inconvenient by requiring a user to physically locate a card and verify the user credentials.

Many people can relate to the inconvenience of accessing a secure area while their hands are full, which inevitably leads to an awkward attempt to access the area or forcing the user to place their items on the ground to take out their card. A key card system is also slower than an automatic system.

### SUMMARY OF THE INVENTION

The instant system, as illustrated herein, is clearly not anticipated, rendered obvious, or even present in any of the prior art mechanisms, either alone or in any combination thereof. A versatile security access system which can be applied doorways and can be adapted to compensate for the aforementioned drawbacks and limitations would afford significant improvement to numerous useful applications. Thus the several embodiments of the instant invention are illustrated herein. It is therefore a primary objective of the system to provide an automatic, hands free door access system that maintains a high level of security.

The instant system utilizes Bluetooth low energy [BTLE] signals to determine when a user is close to an access point and determines whether that user has valid credentials to access the area. If the credentials are valid the user has quick, hands free access to the area.

There has thus been outlined, rather broadly, the more important features of the versatile systems, apparatuses and accompany methods for electronic access, accreditation, validation and tracking, in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carries out in various ways. Also, it is to be understood that the phraseology and terminology employed herein are for the purpose of description and should not be regarded as limiting.

These, together with other objects of the system, along with the various features of novelty, which characterize the system, are pointed out with particularity in the claims annexed to and forming a part of this disclosure. For a better understanding of the interactive systems, apparatuses and accompany methods, the operating advantages and the specific objects attained by usage, reference should be made to the accompanying drawings and descriptive matter in which there are illustrated preferred embodiments of the system.

### BRIEF DESCRIPTION OF THE DRAWINGS

The system may be more completely understood in consideration of the following detailed description of the various embodiments of the system in connection with the accompanying drawings, in which:

FIG. 1 is an overview of a system for operating a mechanical function through a Bluetooth signal.

FIG. 2 is an overview of the server hierarchy.

FIG. 3 is an illustration of an embodiment of a system for operating a mechanical function through a Bluetooth signal.

FIG. 4 is an overview of the path of a signal in a system for operating a mechanical function through a Bluetooth signal.

### DETAILED DESCRIPTION OF THE SEVERAL EMBODIMENTS

For the following defined terms, these definitions shall be applied, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed system.

### Method of Securely Accessing Doors

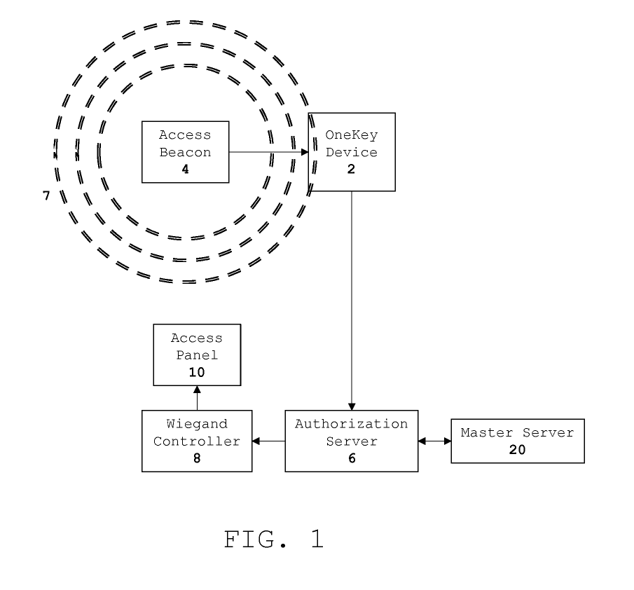

FIG. 1 illustrates one embodiment of a system and method for securely accessing doors. Each device 2 may comprise a unique credential number (or other identification factor) that may be stored in the master server 20. A beacon 4 or other such mechanism may be utilized to broadcast a BILE signal. A OneKey™ device 2 capable of receiving BILE signals is configured with a software system specifically configured to maintain and operate the system (OneKey™ software).

The OneKey™ software runs the BILE of the OneKey™ device's 2 to detect the beacon 4. The OneKey™ device 2 receives a unique credential number from the beacon 4. Next the device 2 communicates with the authorization server 6. The authorization server 6 receives and coordinates which device credential numbers have access to each beacon number from the master server 20.

If the device credential number is associated with the beacon credential number the authorization server 6 sends a signal to the Wiegand controller 8. The Wiegand controller 8 converts the signal to Wiegand security protocol and communicates with the access panel 10. The access panel 10 then opens the door associated with the beacon credential number.

### Master Server Control

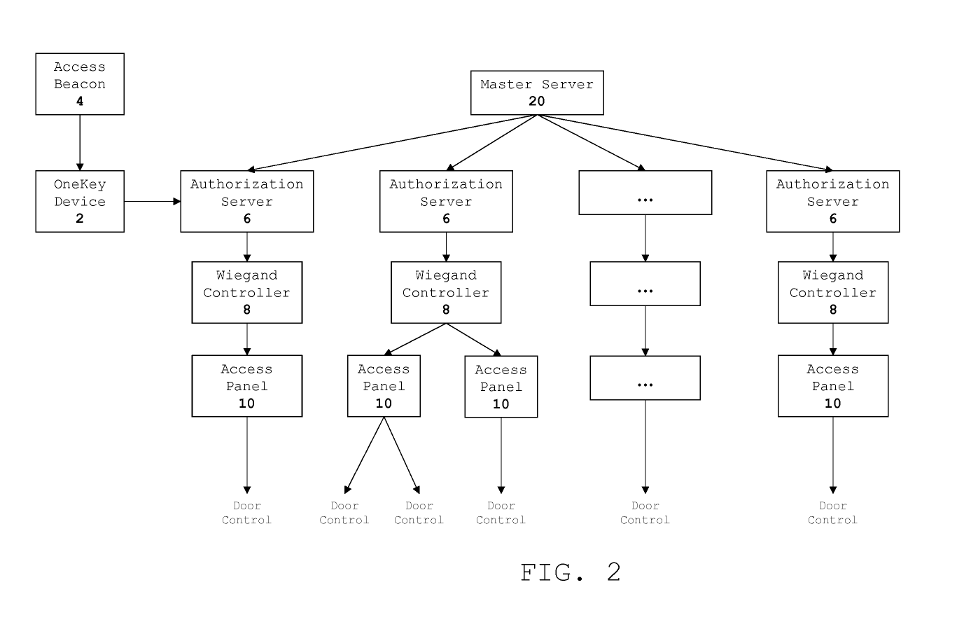

FIG. 2 illustrates an embodiment of the master server control system. The master server 20 has all of the user access codes and keys and supports login and credential sharing for the application. When authorization servers 6 receive a request from a device 2 it pulls a certificate from the master server 20. The authorization server 6 then authenticates the device credential number and validate a door open package.

The master server 20 is communicatively attached to a plurality of authorization servers 6. Each authorization server is communicatively attached to a plurality of beacons 4 and a plurality of Wiegand controllers 8. When an authorization server has verified that a device 2 is authorized to access the door 1 associated with the beacon 4 ID it sends a signal to a plurality of Wiegand controllers 8. The signal to the plurality of Wiegand controllers 8 may be encrypted using a number of encryption methods. The plurality of Wiegand controllers 8 send a Wiegand encrypted signal to a plurality of access panels 10. The access panels 10 open the relevant doors 1.

### Door Control

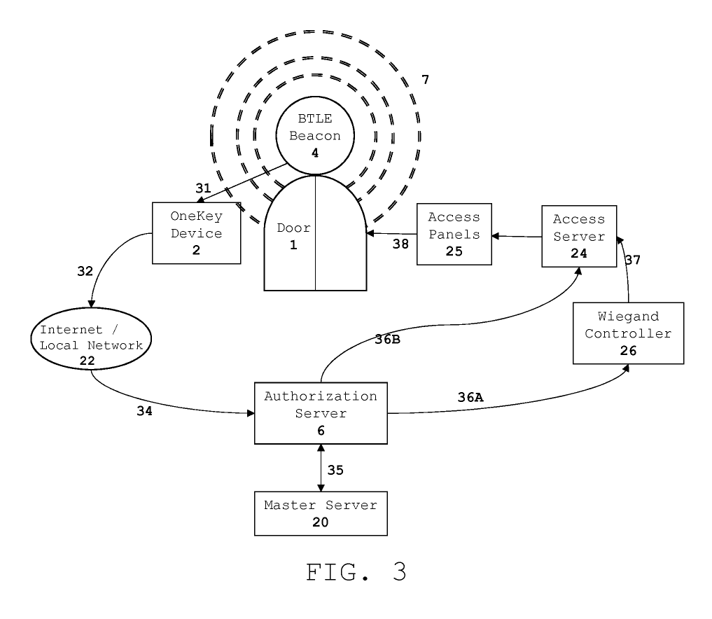

FIG. 3 illustrates an embodiment of the system applied to a standard door 1. In this embodiment a BILE beacon 4 is placed above the door 1, however in other embodiments the beacon 4 may be placed anywhere the owner wants to track devices 2. The BILE beacon 4 constantly broadcasts 7 its credential number. When a device 2 receives a broadcast 7 from a beacon 4 it records the credential number of the beacon 4. In this embodiment, the device 2 then sends a signal 32 with its credential number over the internet 22, however in other embodiments the device 2 may send the signal 32 through other means such as a local network or a BILE signal. In this embodiment, the signal 34 travels to an authorization serer 6, however in other embodiments the signal 34 may be sent directly to a master server 20 or a door access server 24.

When the authorization server 6 receives a signal 34 it verifies 35 with the master server 20 that that device 2 is authorized to access the door 1 associated with that beacon 4. In this embodiment, the device is being used to access a door 1, however in other embodiments the device 2 may be used to access other mechanical devices. The authorization server 6 then sends a signal 36B to a door access server 24 associated with the beacon 4 ID signal 7. The signal 36A may also be sent to a Wiegand controller 26 or other security protocol to ensure that the signal 36A is secure. If the signal is sent to a Wiegand controller 26 the Wiegand controller sends a signal 37 to an access sever 24. The door access server 24 then opens or unlocks 38 the door 1.

The door access server 24 may be utilized to receive network direct open requests. Upon receipt of the network direct open requests, the access server may handle and distribute the load to a set of door access panels 25. The access panel may be characterized as a less “smart” device that handles requests for one or more doors and may comprise a large user list. The set of door access panels 25 may typically be located closer to the individual door or set of doors that the set of door access panels 25 control (at least in the same building or even within feet of an individual door). Thus, a campus of buildings may have as many as 100-1,000 door access panels 25, or even more, as building requirements demand.

### Credentials

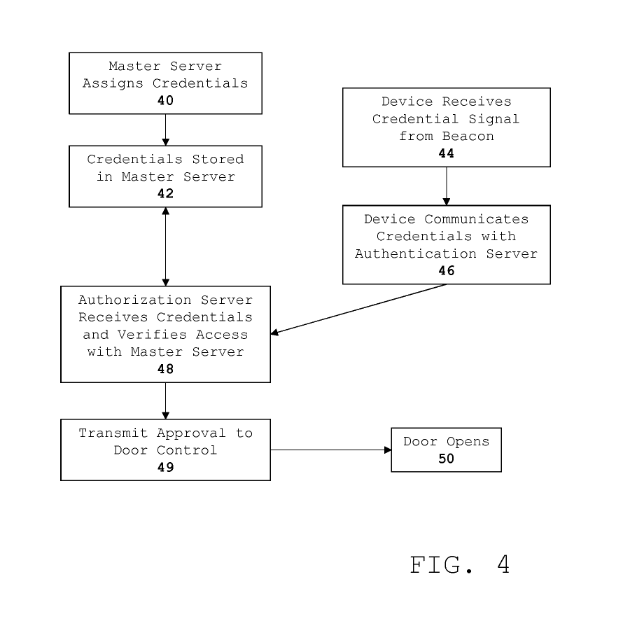

FIG. 4 illustrates how credentials are used to verify access secured doors 1. In this embodiment credentials are used to access doors 1, however in other embodiments credentials may be used to initiate other features. Every device 24 and beacon 4 that operates in the system is assign credentials 40 from a master server 20. The master server 20 stores 42 all assigned credentials. When a device 2 receives a credential signal 44 from a beacon 4 it sends a signal 46 to an authorization server 6.

The authorization server 6 is tasked to verify 48 that the device 2 credentials it receives are authorized to access the specific door 1 associated with the beacon 4 credentials with the master server 20. If the device 2 is authorized to access the door 1 associated with the beacon 4 credentials the master server 20 transmits 49 an approval signal to a door control device. Next the door control device opens the door 1.

What is claimed is:

1. A method for operating a mechanical device comprising:
receiving a credential signal from a beacon within a receiving device;
sending a signal comprised with the devices credentials and the beacon credentials to an authentication server;
verifying that the device credentials have access to the mechanical device associated with the beacon credentials; and
sending a signal to operate the mechanical device.

2. The method for operating a mechanical device of claim 1 wherein the signal from the beacon comprises a Bluetooth signal.

3. The method for operating a mechanical device of claim 1 wherein the signal to operate the mechanical device is routed through a security protocol before operating the mechanical device.

4. The method for operating a mechanical device of claim 3 wherein the signal from the beacon is a Bluetooth signal.

5. The method for operating a mechanical device of claim 3 wherein the security protocol is a wiegand controller

6. The method for operating a mechanical device of claim 5 wherein the signal from the beacon is a Bluetooth signal.

7. The method of claim 1 wherein the mechanical device is a door.

8. The system for operating a mechanical device of claim 7 wherein the signal from the beacon is a Bluetooth signal.

9. The method for operating a door of claim 7 wherein the signal to operate a mechanical device is sent through a security protocol before operating the mechanical device.

10. The method for operating a mechanical device of claim 9 wherein the signal from the beacon is a Bluetooth signal.

11. The method for operating a mechanical device of claim 5 wherein the security protocol is a wiegand controller

12. The method for operating a mechanical device of claim 11 wherein the signal from the beacon is a Bluetooth signal.

13. A system for actuating an entrance mechanism comprising:
a master server;
a device comprising a unique credential number stored in the master server;
a beacon utilized to broadcast a BILE signal;
a beacon credential number;
a OneKey™ device disposed to receive the BILE signal wherein the OneKey™ is comprises a OneKey™ software system specifically configured to maintain and operate the system and further configured to runs the BILE of the OneKey™ device's to detect the beacon;
an authorization server disposed to receive and coordinate which device credential numbers have access to each beacon number from the master server;
a wiegand controller;
an access server;
a set of access panels;
wherein upon verification that the device credential number is associated with the beacon credential number, the authorization server sends a signal to the wiegand controller and wherein the wiegand controller is disposed to convert the signal to a wiegand security protocol and communicate with the access server; wherein the access server communicates with the set of access panels to actuate an entrance mechanism associated with the beacon credential number.
